(19) United States
(12) Patent Application Publication
(10) Pub. No.: US 2026/0175572 A1
(43) Pub. Date: Jun. 25, 2026

(54) LIQUID DISCHARGE HEAD, LIQUID DISCHARGE UNIT, AND LIQUID DISCHARGE APPARATUS

(71) Applicant: Keishi MIWA, Kanagawa (JP)

(72) Inventor: Keishi MIWA, Kanagawa (JP)

(21) Appl. No.: 19/407,004

(22) Filed: Dec. 3, 2025

(30) Foreign Application Priority Data
Dec. 25, 2024 (JP) 2024-229297

(51) Int. Cl. B41J 2/14; B41J 29/02

(52) U.S. Cl. CPC B41J 2/14233; B41J 2/1433; B41J 29/02; B41J 2002/14306; B41J 2002/14419

(57) ABSTRACT

A liquid discharge head includes a nozzle substrate, a channel substrate, a piezoelectric element substrate, a holding substrate, and a frame. The nozzle substrate has a nozzle region having nozzles arrayed in a longitudinal direction of the nozzle region. The nozzle region has a first length in the longitudinal direction. The channel substrate has a first width in a width direction orthogonal to the longitudinal direction. The piezoelectric element substrate has a second width shorter than the first width in the width direction. The holding substrate has a third width shorter than the first width in the width direction. The frame is bonded to the channel substrate, with an adhesive in a bonding region, outside the piezoelectric element substrate and the holding substrate in the width direction. The bonding region has a second length longer than the first length of the nozzle region in the longitudinal direction.

### CROSS-REFERENCE TO RELATED APPLICATION

This patent application is based on and claims priority pursuant to 35 U.S.C. § 119(a) to Japanese Patent Application No. 2024-229297, filed on Dec. 25, 2024, in the Japan Patent Office, the entire disclosure of which is hereby incorporated by reference herein.

### BACKGROUND

### Technical Field

The present disclosure relates to a liquid discharge head, a liquid discharge unit, and a liquid discharge apparatus.

### Related Art

A liquid discharge head employed in an inkjet image forming apparatus is known in the art. Such a liquid discharge head is required to discharge a liquid at a discharge speed having small variations to form high quality images.

Piezoelectric elements are formed on a silicon substrate (piezoelectric element substrate) at high density by using a micro electro mechanical systems (MEMS) process to form the liquid discharge head. To assemble the liquid discharge head, a nozzle substrate, a channel substrate, a frame, and some other components are bonded to the piezoelectric element substrate, for example, with an adhesive. The frame, through which ink is to be supplied, holds these substrates.

### SUMMARY

The present disclosure described herein provides an improved liquid discharge head including a nozzle substrate, a channel substrate, a piezoelectric element substrate, a holding substrate, and a frame. The nozzle substrate having a nozzle region having nozzles arrayed in a longitudinal direction of the nozzle region. The nozzle region has a first length in the longitudinal direction. The channel substrate is disposed over the nozzle substrate. The channel substrate has individual channels respectively communicating with the nozzles and a common channel communicating with the individual channels. The channel substrate has a first width in a width direction orthogonal to the longitudinal direction. The piezoelectric element substrate is disposed over the channel substrate. The piezoelectric element substrate includes individual liquid chambers connecting the individual channels and the common channel, a diaphragm covering the individual liquid chambers, and a piezoelectric element on the diaphragm. The piezoelectric element is opposed to the individual liquid chambers via the diaphragm in a discharge direction orthogonal to the longitudinal direction and the width direction. The piezoelectric element vibrates the diaphragm to discharge a liquid from the nozzles in the discharge direction. The piezoelectric element substrate has a second width shorter than the first width in the width direction. The holding substrate holds the piezoelectric element substrate. The holding substrate has a third width shorter than the first width in the width direction. The frame is bonded to the channel substrate, with an adhesive in a bonding region, outside the piezoelectric element substrate and the holding substrate in the width direction. The frame has another common channel communicating with the common channel of the channel substrate. The bonding region has a second length longer than the first length of the nozzle region in the longitudinal direction.

Further, the present disclosure described herein provides an improved liquid discharge head including a nozzle substrate, a channel substrate, and a frame. The nozzle substrate has a nozzle region having nozzles arrayed in a longitudinal direction of the nozzle region. The nozzle region has a first length in the longitudinal direction. The channel substrate is disposed over the nozzle substrate. The channel substrate has individual channels respectively communicating with the nozzles and a common channel communicating with the individual channels. The frame is bonded to the channel substrate with an adhesive in a bonding region. The frame has another common channel communicating with the common channel of the channel substrate. The bonding region has a second length longer than the first length of the nozzle region in the longitudinal direction.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a schematic view of a liquid discharge head;

FIG. 2 is a schematic diagram of two components bonded to each other, illustrating residual stress caused by a difference in linear expansion coefficient between the two components;

FIG. 3 is a schematic cross-sectional view of a liquid discharge head, illustrating a piezoelectric element substrate and the surroundings thereof;

FIG. 4 is a plan view of a nozzle substrate, a channel substrate, and a frame of an inkjet head according to a comparative example;

FIG. 5 is a graph illustrating a discharge speed of ink in the inkjet head illustrated in FIG. 4;

FIG. 6 is a plan view of a nozzle substrate, a channel substrate, and a frame of an inkjet head according to another comparative example;

FIG. 7 is a graph illustrating a discharge speed of ink in the inkjet head illustrated in FIG. 6;

FIG. 8 is a plan view of a nozzle substrate, a channel substrate, and a frame of an inkjet head according to a first embodiment of the present disclosure;

FIG. 9 is a graph illustrating a discharge speed of ink in the inkjet head illustrated in FIG. 8;

FIG. 10 is a plan view of a nozzle substrate, a channel substrate, and a frame of an inkjet head according to a second embodiment of the present disclosure;

FIG. 11 is a graph illustrating a discharge speed of ink in the inkjet head illustrated in FIG. 10;

FIG. 12 is a plan view of a nozzle substrate, a channel substrate, and a frame of an inkjet head according to a third embodiment of the present disclosure;

FIG. 13 is a schematic front view of a liquid discharge apparatus including a liquid discharge head;

FIG. 14 is a schematic plan view of a liquid discharge unit of the liquid discharge apparatus of FIG. 13 including the liquid discharge head;

FIG. 15 is a schematic plan view of a liquid discharge apparatus including a liquid discharge head;

FIG. 16 is a schematic side view of the liquid discharge apparatus of FIG. 15 including the liquid discharge head;

FIG. 17 is a schematic plan view of a liquid discharge unit of a liquid discharge apparatus including a liquid discharge head;

FIG. 18 is a schematic front view of a liquid discharge unit of a liquid discharge apparatus including a liquid discharge head; and

FIG. 19 is a schematic front view of an electrode manufacturing apparatus as a liquid discharge apparatus including a liquid discharge head.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

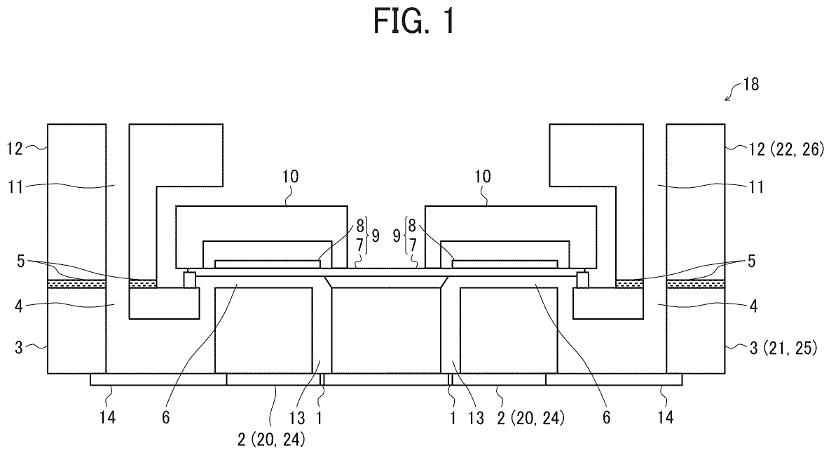

FIG. 1 is a schematic view of a discharge unit of an inkjet head as a liquid discharge head. In FIG. 1, an inkjet head 18 includes a nozzle substrate 2 and a channel substrate 3. The nozzle substrate 2 is disposed at a lower portion of the inkjet head 18 in FIG. 1 and has multiple nozzles 1 through which ink is discharged. The channel substrate 3 is disposed over and bonded to the nozzle substrate 2. The channel substrate 3 has individual channels 13 respectively communicating with the nozzles 1 and a common channel 4 communicating with the individual channels 13 via individual liquid chambers 6. The inkjet head 18 further includes a piezoelectric element substrate 9, a holding substrate 10, and a frame 12. The piezoelectric element substrate 9 is disposed over the channel substrate 3 and has the individual liquid chambers 6 connecting the individual channels 13 and the common channel 4. The piezoelectric element substrate 9 includes a diaphragm 7 covering the individual liquid chambers 6 and a piezoelectric element 8 disposed on the diaphragm 7 to generate driving force. In other words, the individual liquid chambers 6 are formed between the diaphragm 7 and the channel substrate 3. The holding substrate 10 holds the piezoelectric element substrate 9. The holding substrate 10 has a recess in which the piezoelectric element 8 vibrates. The frame 12 is bonded to the channel substrate 3 and has a common channel 11 (i.e., another common channel) communicating with the common channel 4.

In FIG. 1, the left-right direction corresponds to a transverse direction (width direction) of the inkjet head 18, and the direction perpendicular to the surface of the paper on which FIG. 1 is drawn corresponds to a longitudinal direction of the inkjet head 18.

The size (width) of the channel substrate 3 in the transverse direction, i.e., the left-right direction in FIG. 1 is longer than the size (width) of each of the piezoelectric element substrate 9 and the holding substrate 10 in the transverse direction. In FIG. 1, the channel substrate 3 and the frame 12 are directly bonded to each other outside the piezoelectric element substrate 9 and the holding substrate 10 in the transverse direction. Alternatively, the channel substrate 3 and the frame 12 may be bonded to each other via a component thinner than the piezoelectric element substrate 9.

A damper 14 is attached to the face of the channel substrate 3 opposite the face to which the frame 12 is bonded. The damper 14 absorbs pressure generated during ink discharge. Among the above components, for example, the nozzle substrate 2, the channel substrate 3, the piezoelectric element substrate 9, and the holding substrate 10 are formed by processing a single crystal silicon substrate with a semiconductor processing technique (e.g., photolithography or etching) to form fine and complicated patterns on those components at high density in order to form high quality images. The frame 12 is molded from a resin material (e.g., polyphenylene sulfide (PPS) resin, polyphenylene ether (PPE) resin, or glass epoxy resin) to be manufactured at low cost because the frame 12 has no complicated patterns.

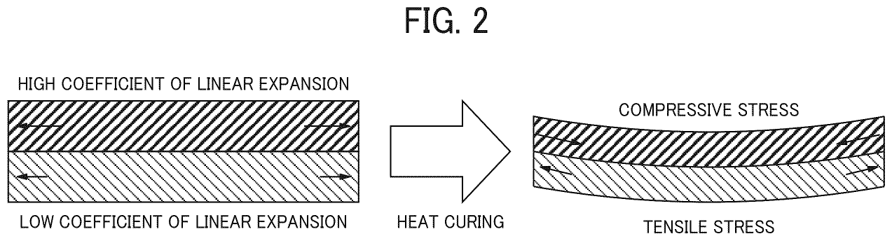

Such processed or molded components are positioned precisely by a positioning process, such as optical alignment or a process using positioning pins, and then bonded and fixed with an adhesive 5. Examples of the adhesive 5 to be used include UV curable adhesive, two-liquid room temperature curable adhesive, and thermosetting adhesive. The adhesive 5 has high durability against ink because the adhesive 5 contacts the ink. In consideration of the relationship between the ink durability and the manufacturing takt time, the thermosetting adhesive may be used as the adhesive 5. In this case, however, residual stress is generated, as illustrated in FIG. 2, due to the difference in linear expansion coefficient between silicon and resin, which are materials for the components to be bonded to each other. The residual stress may cause a discharge speed to vary, which may cause low image quality. The adhesive 5 may include a component thinner than the piezoelectric element substrate.

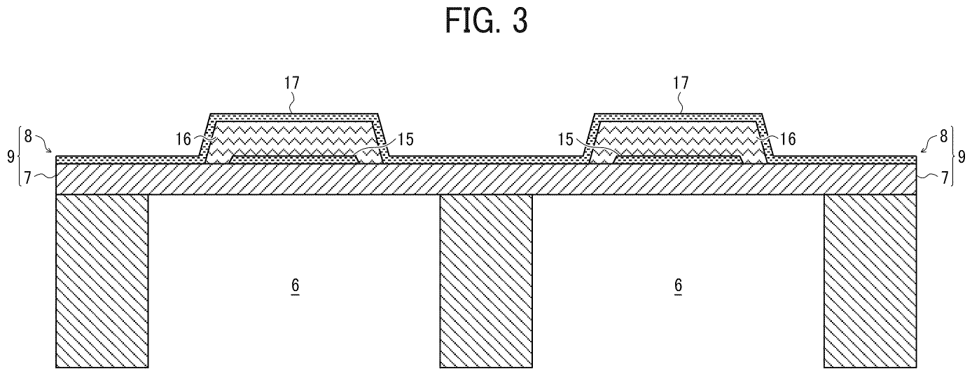

FIG. 3 is a cross-sectional view of the piezoelectric element substrate 9 and the surroundings thereof. The piezoelectric element substrate 9 has a configuration in which the diaphragm 7 covers the individual liquid chambers 6 and the piezoelectric element 8 is disposed on the diaphragm 7. The piezoelectric element 8 includes a common electrode 17 serving as an upper electrode, an individual electrode 15 serving as a lower electrode, and a piezoelectric body 16 disposed between the common electrode 17 and the individual electrode 15. When compressive stress is applied to the diaphragm 7, the diaphragm 7 is loosened so that the piezoelectric element 8 is easily driven, and a displacement amount of the piezoelectric element 8 increases. When tensile stress is applied to the diaphragm 7, the diaphragm 7 is stretched so that the piezoelectric element 8 is not easily driven, and the displacement amount of the piezoelectric element 8 decreases. Since the displacement amount of the piezoelectric element 8 correlates with the discharge speed of liquid, the discharge speed varies depending on the state of the stress applied to the diaphragm 7.

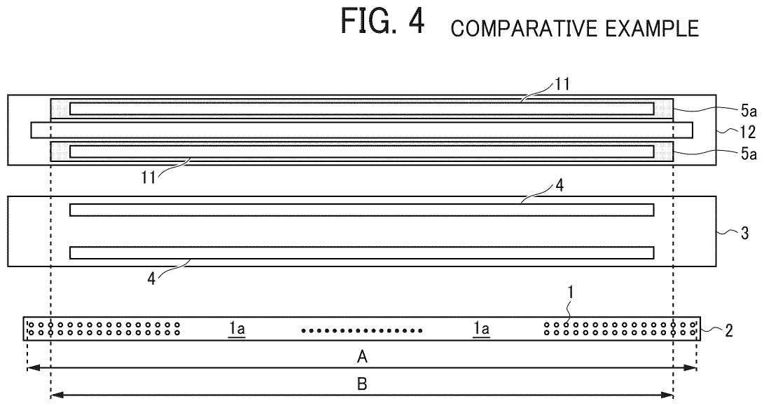

FIG. 4 is a plan view of the nozzle substrate 2, the channel substrate 3, and the frame 12 according to a comparative example. Among these components, the nozzle substrate 2 has a nozzle arrangement region 1a (i.e., a nozzle region) having multiple nozzles 1. The multiple nozzles 1 are arrayed in the entire nozzle arrangement region 1a in the longitudinal direction. The nozzle arrangement region 1a extends across substantially the entire nozzle substrate 2 in the longitudinal direction. In FIG. 4, illustrations of the nozzles 1 and the nozzle arrangement region 1a at or near the center of the nozzle substrate 2 are omitted. The frame 12 has a bonding region 5a to which the channel substrate 3 is bonded so that common channels 4 are coupled to the common channel 11. In other words, the adhesive 5 is applied to the bonding region 5a, and wets and spreads in the bonding region 5a.

In FIG. 4, a length B of the bonding region 5a is shorter than a length A of the nozzle arrangement region 1a. In the following description, the size in the left-right direction as illustrated in FIG. 4 is referred to as the length, and the size in a vertical direction, as illustrated in FIG. 4, orthogonal to the length is referred to as the width.

In this configuration, the length A and the length B are different from each other. In addition, the bonding region 5a is deformed due to the difference in the linear expansion coefficient as described above. In this case, the positions of the nozzles 1 within a part of the nozzle arrangement region 1a corresponding to the bonding region 5a are likely to be displaced, whereas the positions of the nozzles 1 outside the bonding region 5a are less likely to be displaced. This difference in displacement between the nozzles 1 causes the difference in stresses applied. As a result, a discharge speed of the nozzles 1 near both ends of the nozzle substrate 2 differs from a discharge speed of the other nozzles 1.

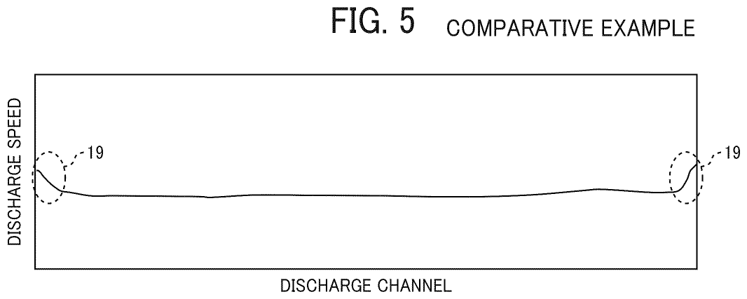

FIG. 5 illustrates variations in the discharge speed (values obtained by dividing the discharge speeds of the individual channels by the average discharge speed) in the configuration of FIG. 4. As illustrated FIG. 5, the discharge speed of the discharge channels corresponding to the bonding region 5a is lower because a larger tensile stress is applied, whereas the discharge speed of the discharge channels near both ends outside the bonding region 5a is higher because a smaller tensile stress is applied. In FIG. 5, the discharge speed near both ends, which are indicated by a dashed circle 19, is relatively high. Accordingly, the configuration according to the comparative example exhibits a distribution of the discharge speed, which largely varies between the discharge channels at the center and the discharge channels near both ends, causing low image quality.

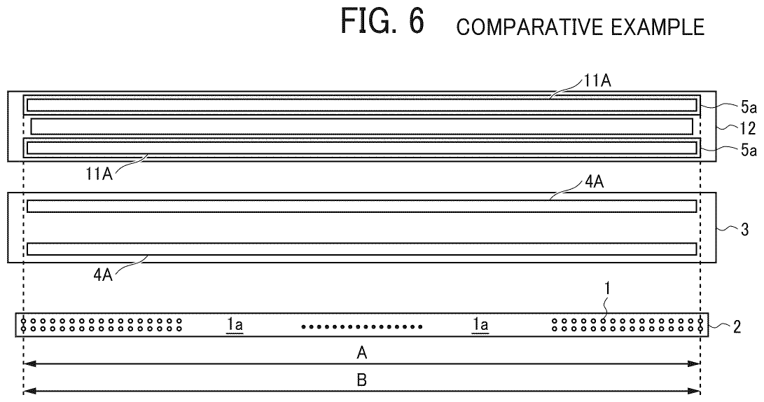

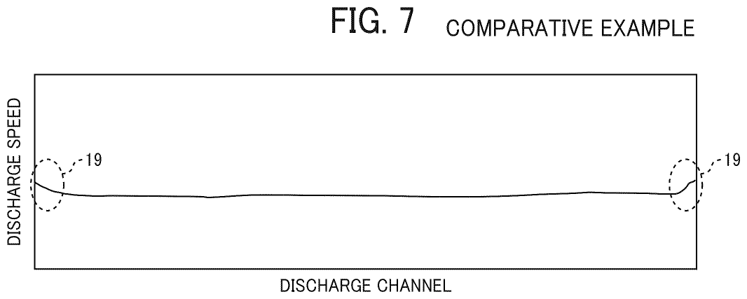

FIG. 6 illustrates another comparative example, which is different from the configuration of FIG. 4. In this example, the length A of the nozzle arrangement region 1a is unchanged, and the length B of the bonding region 5a is increased to substantially the same as the length A. In addition, common channels 4A and 11A are longer than the common channels 4 and 11, respectively. FIG. 7 illustrates variations in the discharge speed in the configuration of FIG. 6. The variations in the discharge speed in the configuration of FIG. 6 are smaller than the variations in the discharge speed in the configuration of FIG. 4, but as illustrated in FIG. 7, the variations in the discharge speed near both ends indicated by the dashed circle 19 are still large.

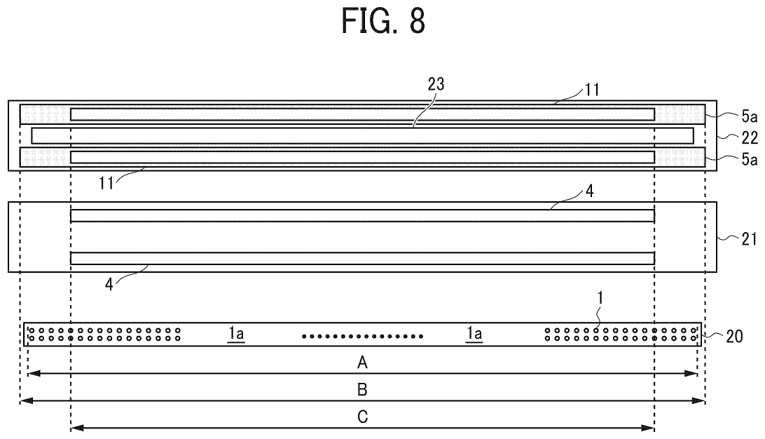

A description will be given below of a first embodiment of the present disclosure, in which the variations in the discharge speed are reduced. FIG. 8 is a plan view of a nozzle substrate 20, a channel substrate 21, and a frame 22 of an inkjet head 18 according to the first embodiment of the present disclosure. Similarly to the nozzle substrate 2 illustrated in FIG. 4, the nozzle substrate 20 has the multiple nozzles 1 and the nozzle arrangement region 1a (i.e., the nozzle region). The channel substrate 21 has the common channels 4 at two positions, similarly to the configuration of FIG. 4. In FIG. 8, illustrations of channels other than the common channels 4 in the channel substrate 21 are omitted. The inkjet head 18 includes the nozzle substrate 20, the channel substrate 21, and the frame 22 instead of the nozzle plate 2, the channel plate 3, and the frame 12, respectively. In other words, the inkjet head 18 illustrated in FIG. 8 has substantially the same configuration as the inkjet head 18 illustrated in FIGS. 1 and 3.

Similarly to the configuration of FIG. 4, the frame 22 has the common channels 11 (i.e., another common channel) at two positions and a through hole having an opening 23 at the center thereof in a width direction of the frame 22 (i.e., the transverse direction). Similarly to the frame 12 illustrated in FIG. 4, the frame 22 has the bonding region 5a to which the adhesive 5 is applied, and wets and spreads thereon. However, in the configuration of FIG. 8, the length B of the bonding region 5a is longer than the length A of the nozzle arrangement region 1a. In addition, a length C of the common channels 4 and 11 is shorter than the length A.

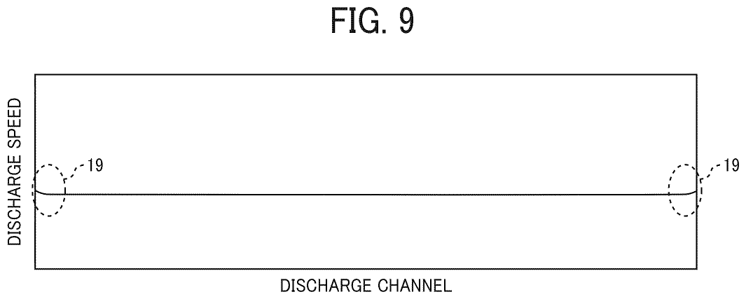

With this configuration, tensile stress generated when the adhesive 5 is cured is uniformly applied to the entire nozzle arrangement region 1a. Accordingly, the inkjet head 18 can be provided that can reduce variations in the discharge speed near both ends indicated by the dashed circle 19 as illustrated in FIG. 9 and also can reduce variations in the discharge speed in the nozzle arrangement region 1a, to prevent low image quality. The distance between one end of the nozzle arrangement region 1a and the corresponding end of the bonding region 5a, i.e., the difference between the length A and the length B at each end is preferably 1 mm or more. In this case, the length C is shorter than the length A, so that the inkjet head 18 can be downsized.

Since the frame 22 has the opening 23 at the center, tensile stress generated during bonding and fixing can be reduced. Accordingly, variations in the discharge speed in the nozzle arrangement region 1a can be reduced.

Furthermore, to reduce the influence of stress on the diaphragm 7, preferably, the frame 22 is not bonded to the holding substrate 10, similarly to the frame 12 illustrated in FIG. 1. Thus, variations in the discharge speed can be reduced. If the frame 22 is bonded to the holding substrate 10, the bonded area therebetween is preferably wider (longer) than the nozzle arrangement region 1a to reduce variations in the discharge speed. Moreover, the channel substrate 3 and the frame 12 are preferably bonded to each other outside the diaphragm 7 in the transverse direction of the inkjet head 18 as illustrated in FIG. 1. In other words, the channel substrate 3 and the frame 12 are preferably bonded to each other outside the piezoelectric element substrate 9 and the holding substrate 10. This configuration can reduce the influence of stress on the diaphragm 7 to reduce variations in the discharge speed.

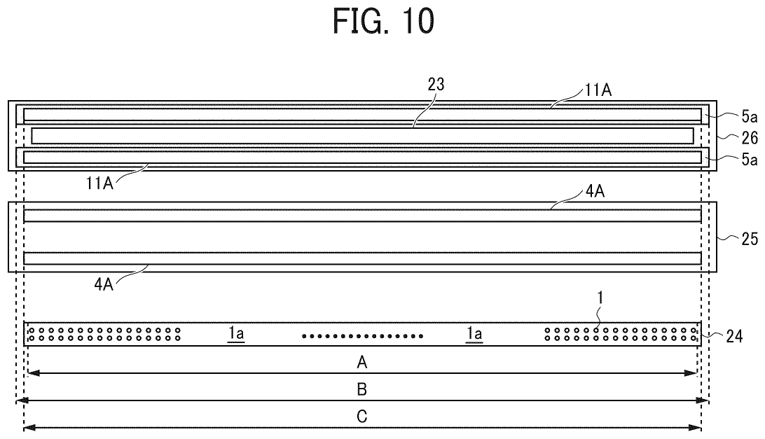

FIG. 10 is a plan view of a nozzle substrate 24, a channel substrate 25, and a frame 26 of an inkjet head 18 according to a second embodiment of the present disclosure. The nozzle substrate 24 has the multiple nozzles 1 and the nozzle arrangement region 1a (i.e., the nozzle region). The channel substrate 25 has the common channels 4A at two positions, similarly to the configuration of FIG. 6. In FIG. 10, illustrations of channels other than the common channels 4A in the channel substrate 25 are omitted. Similarly to the configuration of FIG. 6, the frame 26 has the common channels 11A (i.e., another common channel) at two positions and the opening 23 at the center thereof in the width direction. The frame 26 has the bonding region 5a. In the configuration of FIG. 10, the length B of the bonding region 5a is longer than the length A of the nozzle arrangement region 1a. In addition, the length C of the common channels 4A and 11A is longer than the length A of the nozzle arrangement region 1a.

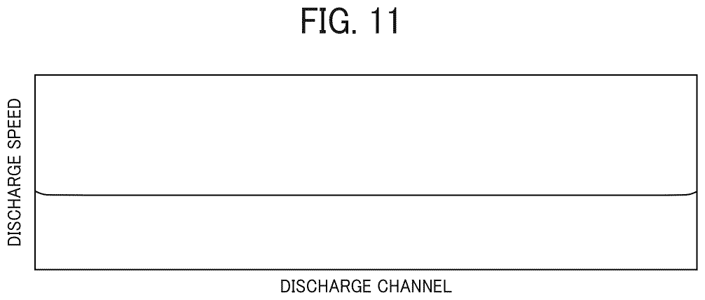

Similarly to the first embodiment, this configuration can provide the inkjet head 18 in which the adhesive 5 seals portions surrounding the common channels 4A and 11A to reduce variations in the discharge speed near both ends as illustrated in FIG. 11 and also to reduce variations in the discharge speed in the nozzle arrangement region 1a so as to prevent low image quality. Furthermore, since the length C is longer than the length A, ink can be uniformly supplied to all the nozzles 1 in the nozzle arrangement region 1a to make the discharge speed of the ink further uniform.

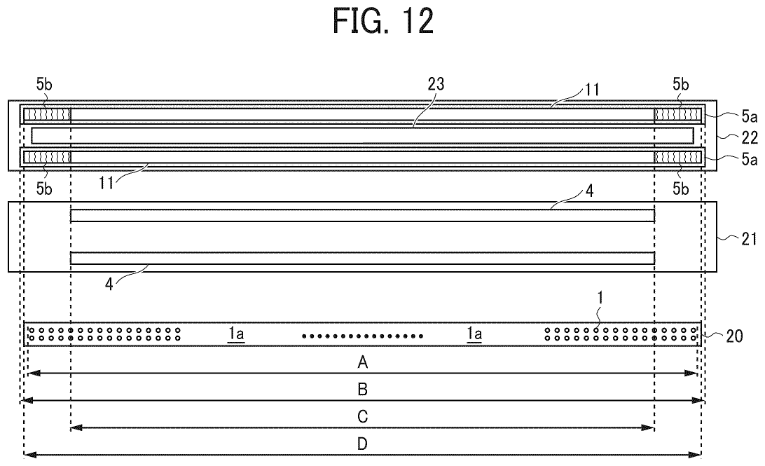

FIG. 12 illustrates a third embodiment of the present disclosure. A configuration of the third embodiment is different from the configuration of the first embodiment illustrated in FIG. 8 in that the bonding region 5a includes a bonding part surrounding a non-bonding part 5b to which the adhesive 5 is not applied, outside the common channels 4 and 11 at each end in the longitudinal direction, and other configurations are the same. In FIG. 12, illustrations of channels other than the common channels 4 in the channel substrate 21 are omitted.

With this configuration, an area of the bonding region 5a to which the adhesive 5 is actually applied can be substantially the same as the area of the nozzle arrangement region 1a. As a result, tensile stress is uniformly applied to the entire nozzle arrangement region 1a to further reduce variations in the discharge speed.

In the third embodiment, the width of the non-bonding part 5b is the same as the width of the common channel 11. Thus, the area of the bonding region 5a to which the adhesive 5 is actually applied can be brought closer to the area of the nozzle arrangement region 1a. As a result, tensile stress is uniformly applied to the entire nozzle arrangement region 1a to further reduce variations in the discharge speed.

Furthermore, the outer end of the non-bonding part 5b in the longitudinal direction extends to the outside of the nozzle arrangement region 1a (a length D between both outer ends of the non-bonding parts 5b in the longitudinal direction is longer than the length A). Thus, the area of the bonding region 5a to which the adhesive 5 is actually applied can be brought closer to the area of the nozzle arrangement region 1a. As a result, tensile stress is uniformly applied to the entire nozzle arrangement region 1a to further reduce variations in the discharge speed.

Moreover, the adhesive 5 is applied to a portion of the frame 22 outside the non-bonding part 5b in the longitudinal direction. Thus, the bonding region 5a can form a closed area surrounding the non-bonding part 5b to reliably prevent leakage of the ink from the common channels 4 and 11.

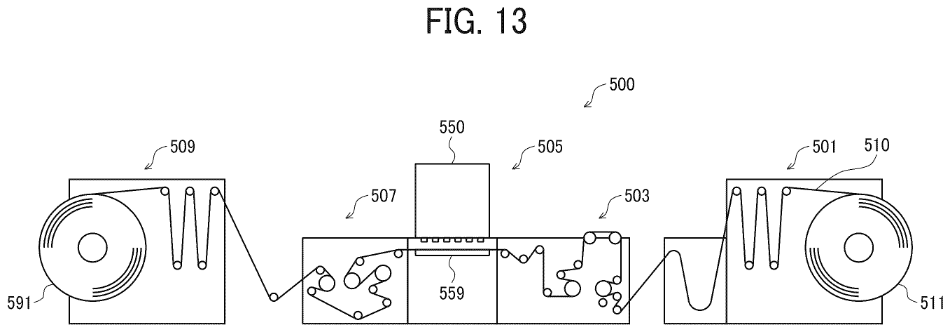

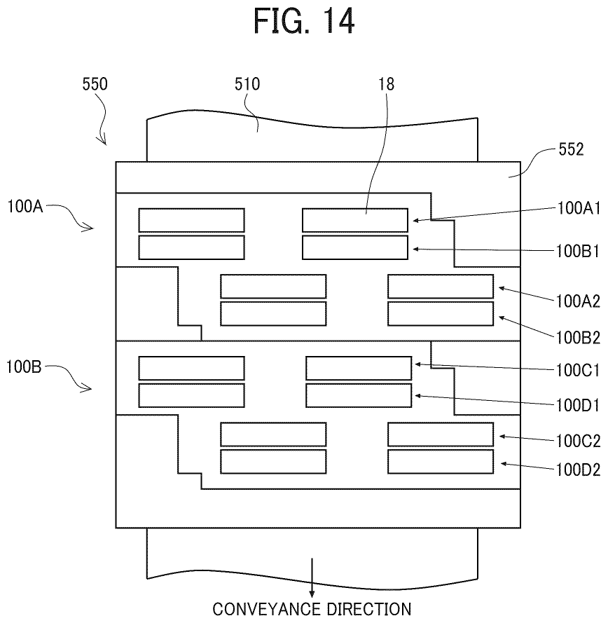

A description is given below of another liquid discharge apparatus including the inkjet head 18. As illustrated in FIGS. 13 and 14, a printer 500 serving as the liquid discharge apparatus includes a feeder 501 to feed a continuous medium 510 as a recording medium, a guide conveyor 503 to guide and convey the continuous medium 510, fed from the feeder 501, to a printing unit 505. The printer 500 further includes the printing unit 505 to discharge a liquid onto the continuous medium 510 to form an image on the continuous medium 510, a dryer 507 to dry the continuous medium 510 to which the liquid adheres, and a carrier 509 to feed the dried continuous medium 510 outward.

The continuous medium 510 is fed from a winding roller 511 of the feeder 501, guided and conveyed with rollers of the feeder 501, the guide conveyor 503, the dryer 507, and the carrier 509, and wound around a take-up roller 591 of the carrier 509. These rollers serve as a conveyor to convey the continuous medium 510.

In the printing unit 505, the continuous medium 510 is conveyed on a conveyance guide 559 so as to face a head unit 550 as a liquid discharge unit. The head unit 550 discharges a liquid onto the continuous medium 510 to print an image.

The printer 500 includes liquid discharge units 100A and 100B in the head unit 550. The liquid discharge units 100A and 100B are mounted on a common base 552. The liquid discharge unit 100A includes head arrays 100A1, 100B1, 100A2, and 100B2. Each of the head arrays 100A1, 100B1, 100A2, and 100B2 includes multiple inkjet heads 18 arranged in a head array direction perpendicular to a conveyance direction of the continuous medium 510.

The liquid discharge unit 100B includes head arrays 100C1, 100D1, 100C2, and 100D2. Each of the head arrays 100C1, 100D1, 100C2, and 100D2 includes multiple inkjet heads 18 arranged in the head array direction. The head arrays 100A1 and 100A2 of the liquid discharge unit 100A discharge liquid of the same color. Similarly, the head arrays 100B1 and 100B2 of the liquid discharge unit 100A are grouped as one set and discharge liquid of the same desired color. The head arrays 100C1 and 100C2 of the liquid discharge unit 100B are grouped as one set and discharge liquid of the same desired color. The head arrays 100D1 and 100D2 of the liquid discharge unit 100B are grouped as one set and discharge liquid of the same desired color.

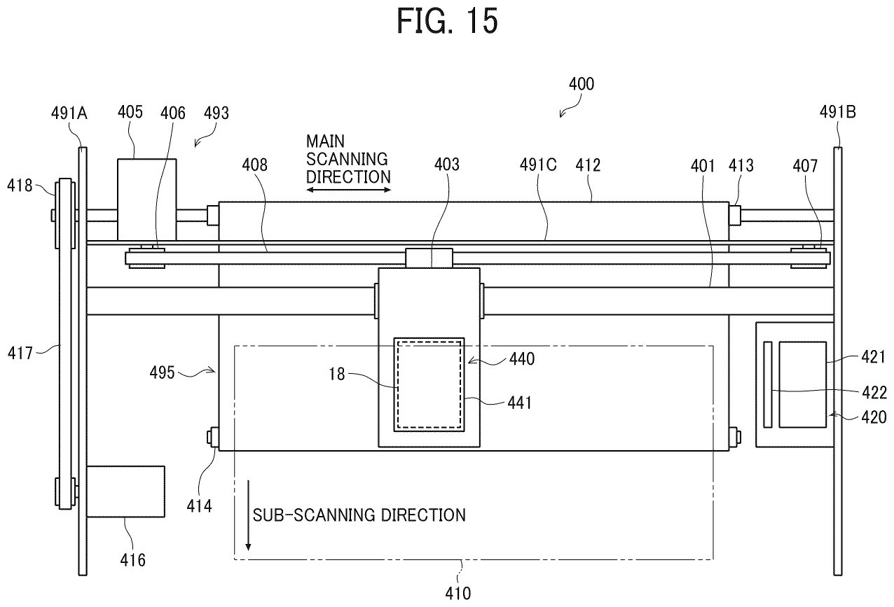

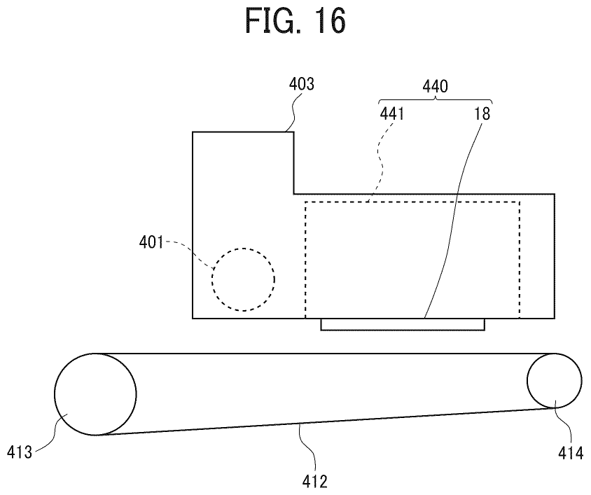

Another printer 400 as a liquid discharge apparatus is described below with reference to FIGS. 15 and 16. As the liquid discharge apparatus, the printer 400 is a serial type printing apparatus, and a main-scanning moving mechanism 493 reciprocally moves a carriage 403 in a main scanning direction. The main-scanning moving mechanism 493 includes a guide 401, a main scanning motor 405, and a timing belt 408. The guide 401 is bridged between left and right side plates 491A and 491B to movably hold the carriage 403. The carriage 403 is reciprocally moved in the main scanning direction by driving force of the main scanning motor 405 transmitted via the timing belt 408 looped around a drive pulley 406 and a driven pulley 407.

The carriage 403 mounts a liquid discharge unit 440 including the inkjet head 18 and a head tank 441 as a single integrated unit. The inkjet head 18 discharges color liquids of, for example, yellow (Y), cyan (C), magenta (M), and black (K). The inkjet head 18 is mounted on the liquid discharge unit 440 such that a nozzle array includes the multiple nozzles arranged in a sub-scanning direction perpendicular to the main scanning direction. The inkjet head 18 discharges the color liquid downward from the multiple nozzles. The inkjet head 18 is coupled to a liquid circulation device so that a liquid of a desired color is circulated and supplied to the inkjet head 18.

The printer 400 includes a conveyance mechanism 495 to convey a sheet 410 as the recording medium. The conveyance mechanism 495 includes a conveyance belt 412 as a conveyor and a sub-scanning motor 416 to drive the conveyance belt 412. The conveyance belt 412, which is an endless belt, is stretched between a conveyance roller 413 and a tension roller 414, and conveys the sheet 410 at a position facing the inkjet head 18 while attracting the sheet 410. The sheet 410 can be attracted to the conveyance belt 412 by, for example, electrostatic attraction or air suction. The conveyance belt 412 is circumferentially moved in the sub-scanning direction by driving force of the sub-scanning motor 416 transmitted via a timing belt 417 and a timing pulley 418.

On one end of the range of movement of the carriage 403 in the main scanning direction, a maintenance mechanism 420 that maintains and recovers the inkjet head 18 is disposed lateral to the conveyance belt 412. The maintenance mechanism 420 includes, for example, a cap 421 to cap a nozzle face (i.e., a face on which the multiple nozzles are formed) of the inkjet head 18 and a wiper 422 to wipe the nozzle face. The main-scanning moving mechanism 493, the maintenance mechanism 420, and the conveyance mechanism 495 are mounted onto a housing including the side plates 491A and 491B and a back plate 491C.

In the printer 400 having the above-described configuration, the sheet 410 is attracted on the conveyance belt 412 and conveyed in the sub-scanning direction by the circumferential movement of the conveyance belt 412. The inkjet head 18 is driven in response to an image signal while the carriage 403 moves in the main scanning direction to discharge a liquid onto the sheet 410 not in motion. As a result, an image is formed on the sheet 410.

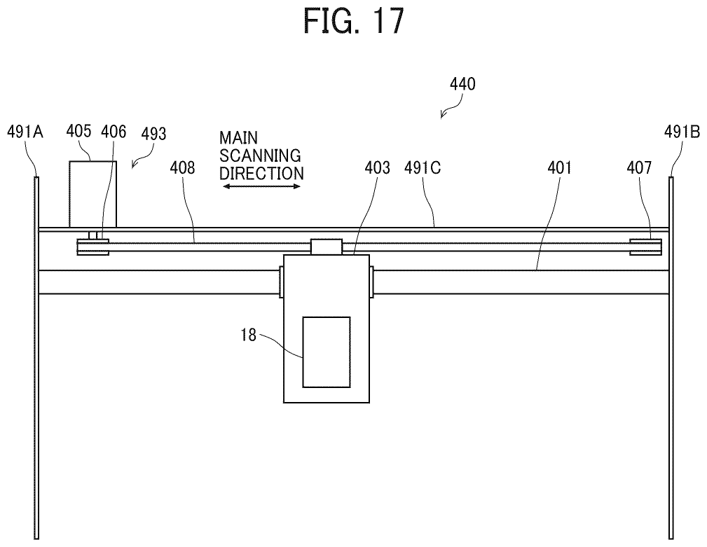

The above-described liquid discharge unit 440 is described below with reference to FIG. 17. The liquid discharge unit 440 includes the housing, the main-scanning moving mechanism 493, the carriage 403, and the inkjet head 18 among components of the printer 400 as the liquid discharge apparatus. The side plates 491A and 491B, and the back plate 491C construct the housing. In the liquid discharge unit 440, the maintenance mechanism 420 described above may be mounted on, for example, the side plate 491B.

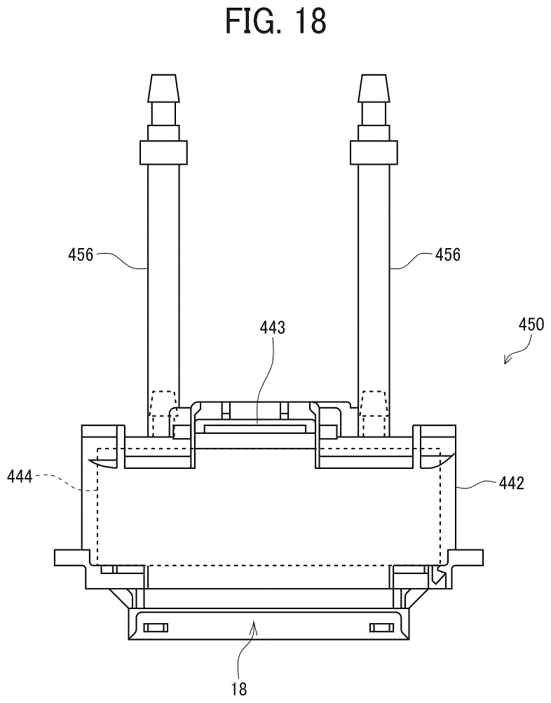

Another liquid discharge unit 450 is described below with reference to FIG. 18. The liquid discharge unit 450 illustrated in FIG. 18 includes the inkjet head 18 to which a channel component 444 is attached, and a tube 456 connected to the channel component 444. The channel component 444 is disposed inside a cover 442, and a connector 443 for electrically connecting to the inkjet head 18 is disposed on an upper portion of the channel component 444. In some embodiments, the liquid discharge unit 450 may include the head tank 441 instead of the channel component 444.

Each of the liquid discharge units 100, 100A, 100B, 440, 450, and 550 and each of the printers 400 and 500 as the liquid discharge apparatus, which includes the inkjet head 18 described above, can attain the same operational effects as the operational effects of the inkjet head 18 described above.

In the present disclosure, the properties of the liquid to be used is not limited as long as the liquid has a viscosity or surface tension to be discharged from a head (liquid discharge head). However, preferably, the viscosity of the liquid is not greater than 30 millipascal-second (mPa·s) under ordinary temperature and ordinary pressure or by heating or cooling. Examples of the liquid include a solution, a suspension, or an emulsion that contains, for example, a solvent, such as water or an organic solvent; a colorant, such as dye or pigment; a functional material, such as a polymerizable compound, a resin, or a surfactant; a biocompatible material, such as deoxyribonucleic acid (DNA), amino acid, protein, or calcium; or an edible material, such as a natural colorant. Such a solution, a suspension, or an emulsion can be used for, e.g., inkjet ink, surface treatment solution, or a material solution for three-dimensional fabrication.

Examples of an energy source for generating energy to discharge liquid include a piezoelectric actuator (a laminated piezoelectric element or a thin-film piezoelectric element), a thermal actuator that employs a thermoelectric transducer, such as a thermal resistor, and an electrostatic actuator including a diaphragm and opposed electrodes.

The pressure generator used in the liquid discharge head is not limited to a particular type of pressure generator. In addition to the above-described piezoelectric actuator (which may use a laminated piezoelectric element), for example, a thermal actuator using a thermoelectric transducer such as a thermal resistor, and an electrostatic actuator including a diaphragm and opposed electrodes can be used.

The “liquid discharge unit” is an assembly of parts relating to liquid discharge. The term “liquid discharge unit” represents a structure including the liquid discharge head and a functional component(s) or mechanism(s) combined with the liquid discharge head as a single unit. For example, the “liquid discharge unit” includes a combination of the liquid discharge head with at least one of a head tank, a carriage, a supply mechanism, a maintenance mechanism, a main-scanning moving mechanism, or a liquid circulation device.

The above integration may be achieved by, for example, a combination in which the liquid discharge head and a functional part(s) are secured to each other through, e.g., fastening, bonding, or engaging, and a combination in which one of the liquid discharge head and a functional part(s) is movably held by the other. The liquid discharge head may be detachably attached to the functional part(s) or mechanism(s) each other.

The liquid discharge head and the head tank may be assembled, or the liquid discharge head and the head tank may be coupled (connected) to each other via, for example, a tube to form the liquid discharge unit as a single unit. A unit including a filter may further be added to a portion between the head tank and the liquid discharge head of the liquid discharge unit.

The liquid discharge unit may be an integrated unit in which the liquid discharge head and the carriage are integrated as a single unit, or the liquid discharge head, the carriage, and the main-scanning moving mechanism are integrated as a single unit. As yet another example, the liquid discharge unit is a unit in which the liquid discharge head and a scanning moving mechanism are combined into a single unit. The liquid discharge head is movably held by a guide that is a part of the scanning moving mechanism.

In another example, the cap that forms a part of the maintenance mechanism is fixed to the carriage mounting the liquid discharge head so that the liquid discharge head, the carriage, and the maintenance mechanism are integrated as a single unit to form the liquid discharge unit. Further, in another example, the liquid discharge unit includes a tube connected to the liquid discharge head mounting the head tank or the channel component so that the liquid discharge head and the supply mechanism are integrated as a single unit. Through the tube, the liquid in a liquid storage source is supplied to the liquid discharge head.

The main-scanning moving mechanism may be a guide only. The supply mechanism may be a tube(s) only or a loading unit only.

Although the liquid discharge unit includes the liquid discharge head as described above, examples of the liquid discharge unit include a head module and the head unit including the above-described liquid discharge head, with which the above-described functional components or mechanisms are combined to form a single unit.

The liquid discharge apparatus used herein also represents a liquid discharge apparatus including the liquid discharge head, the liquid discharge unit, the head module, or the head unit to drive the liquid discharge head to discharge liquid. The liquid discharge apparatus used herein includes, in addition to apparatuses to discharge liquid to a medium onto which liquid can adhere, apparatuses to discharge the liquid into gas (air) or a different liquid.

The liquid discharge apparatus may further include devices relating to feeding, conveying, and ejecting of the medium onto which liquid can adhere and also include a pretreatment device and an aftertreatment device.

The liquid discharge apparatus may be, for example, an image forming apparatus to form an image on a recording medium by discharging ink, or a three-dimensional fabrication apparatus to discharge fabrication liquid to a powder layer in which powder material is formed in layers to form a three-dimensional object.

The liquid discharge apparatus is not limited to an apparatus that discharges liquid to visualize meaningful images such as letters or figures. For example, the liquid discharge apparatus may be an apparatus that forms patterns having no meaning or an apparatus that fabricates three-dimensional images.

The medium onto which liquid can adhere described above represents a medium onto which liquid is at least temporarily adhered, a medium onto which liquid is adhered and fixed, or a medium into which liquid adheres and permeates. Examples of the medium onto which liquid can adhere include recording media, such as paper sheet, recording paper, recording sheet of paper, film, and cloth, electronic components, such as electronic substrate and piezoelectric element, and media, such as powder layer, organ model, and testing cell. The medium onto which liquid can adhere includes any material to which liquid adheres, unless otherwise specified.

Examples of the material of the medium onto which liquid can adhere include any materials to which liquid can adhere even temporarily, such as paper, thread, fiber, fabric, leather, metal, plastic, glass, wood, and ceramic.

The liquid discharge apparatus moves the liquid discharge head and the medium onto which liquid can adhere relative to each other. Which of the liquid discharge head or the medium onto which liquid can adhere is moved is not limited. For example, the liquid discharge apparatus may be a serial head apparatus that moves the liquid discharge head or a line head apparatus that does not move the liquid discharge head.

Examples of the liquid discharge apparatus further include: a treatment liquid applying apparatus that discharges a treatment liquid onto a sheet to apply the treatment liquid to the surface of the sheet, for reforming the surface of the sheet; and an injection granulation apparatus that injects a composition liquid, in which a raw material is dispersed in a solution, through a nozzle to granulate fine particles of the raw material.

The liquid discharge apparatus may also include an apparatus for manufacturing an electrode and an electrochemical element, which is also referred to as an electrode manufacturing apparatus. The electrode manufacturing apparatus is described below.

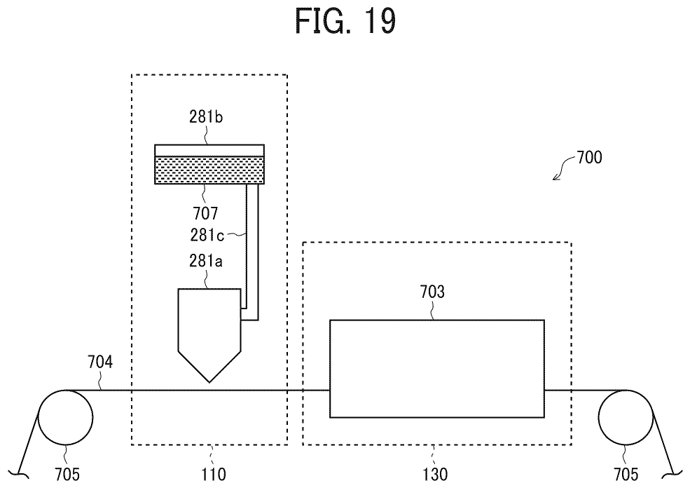

FIG. 19 is a schematic view of an electrode manufacturing apparatus. The electrode manufacturing apparatus 700 is an apparatus for manufacturing an electrode including a layer containing an electrode material by discharging a liquid composition using a liquid discharge unit including a liquid discharge head. A description is given below of a device and process for forming a layer containing an electrode material.

The liquid discharge device in the electrode manufacturing apparatus 700 illustrated in FIG. 19 is the liquid discharge unit described above. The liquid discharge head of the liquid discharge unit discharges a liquid composition. By so doing, the liquid composition is applied onto an object, and a liquid composition layer is formed on the object. The object, which may also be referred to as a discharge target in the following description, is not limited to any particular object and may be appropriately selected depending on the intended purpose, as long as the object is an object on which a layer containing an electrode material is to be formed. Examples of the object include an electrode substrate, i.e., a current collector, an active material layer, and a layer containing a solid electrode material. The object may be an electrode composite layer containing an active material on an electrode substrate. A discharge device (e.g., a discharge process device 110) and a discharge process may be a device and a process of forming a layer containing an electrode material by directly discharging a liquid composition as long as the layer containing an electrode material can be formed on a discharge target. The discharge device and the discharge process may be a device and a process of forming a layer containing an electrode material by indirectly discharging a liquid composition.

Other configurations and processes are described below. Other configurations included in the electrode manufacturing apparatus for manufacturing an electrode composite layer are not limited to any particular configuration and may be appropriately selected depending on the intended purpose, as long as the effects of the present embodiment are not impaired. Other processes included in the method for manufacturing an electrode composite layer are not limited to any particular process and may be appropriately selected depending on the intended purpose, as long as the effects of the present embodiment are not impaired. For example, a heating device and a heating process are examples of the configuration and the process included in the electrode manufacturing apparatus and the manufacturing method of the electrode composite layer.

The heating device and the heating process are described below. The heating device (e.g., a heating process device 130) included the electrode manufacturing apparatus for manufacturing an electrode composite layer is a device that heats the liquid composition discharged by the discharge device. The heating process included in the manufacturing method for manufacturing an electrode composite layer is a process of heating the liquid composition discharged in the discharge process. The liquid composition is heated to dry the liquid composition layer.

A description is given below of a structure to form a layer containing an electrode material by directly discharging a liquid composition. An electrode manufacturing apparatus, which forms a layer containing an electrode material, is described below. The electrode manufacturing apparatus forms an electrode composite layer containing an active material on an electrode substrate (current collector). As illustrated in FIG. 19, the electrode manufacturing apparatus 700 includes the discharge process device 110 and the heating process device 130. The discharge process device 110 performs a discharge process of applying a liquid composition onto a print base material 704 having a discharge target to form a liquid composition layer. The heating process device 130 performs a heating process of heating the liquid composition to obtain an electrode composite layer.

The electrode manufacturing apparatus 700 further includes a conveyance unit 705 that conveys the print base material 704. The conveyance unit 705 conveys the print base material 704 to the discharge process device 110 and the heating process device 130 in this order at a preset speed. A method of producing the print base material 704 having the discharge target such as an active material layer is not limited to any particular method, and a known method can be appropriately selected. The discharge process device 110 includes a liquid discharge head 281a that performs an application process of applying the liquid composition onto the print base material 704, a storage container 281b that stores a liquid composition 707, and a supply tube 281c that supplies the liquid composition 707 in the storage container 281b to the liquid discharge head 281a.

The discharge process device 110 discharges the liquid composition 707 from the liquid discharge head 281a so that the liquid composition 707 is applied onto the print base material 704 to form a liquid composition layer in a thin film shape. The storage container 281b may be integrated with the electrode manufacturing apparatus 700 that forms the electrode composite layer or may be detachable from the electrode manufacturing apparatus 700. The storage container 281b may be a container additionally attachable to a container integrated with the electrode manufacturing apparatus 700 for manufacturing the electrode composite layer or to a container detachable from the electrode manufacturing apparatus 700 for manufacturing the electrode composite layer. The storage container 281b that stably stores the liquid composition 707 and the supply tube 281c that stably supplies the liquid composition 707 can be used.

The heating process device 130 performs a solvent removal process of heating and removing the solvent remaining in the liquid composition layer. Specifically, the solvent that remains in the liquid composition layer is heated and dried by a heater 703 of the heating process device 130 to remove the solvent from the liquid composition layer. Accordingly, the electrode composite layer is formed. The heating process device 130 may perform the solvent removal process under reduced pressure.

The heater 703 is not limited to any particular heater and may be appropriately selected depending on the intended purpose. For example, the heater 703 may be a substrate heater, an infrared (IR) heater, or a hot air heater. The heater 703 may be a combination of at least two of the substrate heater, the IR heater, and the hot air heater. A heating temperature and heating time can be appropriately selected according to the boiling point of the solvent contained in the liquid composition 707 or the thickness of a formed film.

In the electrode manufacturing apparatus 700, a liquid discharge head similar to the inkjet head 18 described above is used as the liquid discharge head 281a. The electrode manufacturing apparatus 700 is used to discharge the liquid composition to a desired position on the discharge target. The electrode composite layer can be suitably used, for example, as a part of the configuration of an electrochemical element. The configuration of the electrochemical element other than the electrode composite layer is not limited to any particular configuration, and a known configuration can be appropriately selected. Examples of the configuration other than the electrode composite layer include a positive electrode, a negative electrode, and a separator.

Aspects of the present disclosure are, for example, as follows.

### Aspect 1

According to Aspect 1, a liquid discharge head includes a nozzle substrate, a channel substrate, a piezoelectric element substrate, a holding substrate, and a frame. The nozzle substrate has a nozzle arrangement region in which multiple nozzles, through which a liquid is discharged, are arranged. The channel substrate has a first common channel communicating with the nozzle. The piezoelectric element substrate has an individual channel communicating with the nozzle, a diaphragm formed so as to cover the individual channel, and a piezoelectric element disposed in the individual channel. The holding substrate has a recess within a region in which the piezoelectric element vibrates. The frame has a second common channel communicating with the first common channel. A size of the channel substrate in a transverse direction thereof is larger than each of sizes of the piezoelectric element substrate and the holding substrate in the transverse direction. The channel substrate and the frame are bonded to each other directly or via a component thinner than the piezoelectric element substrate, outside the piezoelectric element substrate and the holding substrate in the transverse direction. The first common channel and the second common channel are bonded to each other with an adhesive. A length of a bonding region of the first common channel and the second common channel is longer than a length of the nozzle arrangement region.

In other words, a liquid discharge head includes a nozzle substrate, a channel substrate, a piezoelectric element substrate, a holding substrate, and a frame. The nozzle substrate having a nozzle region having nozzles arrayed in a longitudinal direction of the nozzle region. The nozzle region has a first length in the longitudinal direction. The channel substrate is disposed over the nozzle substrate. The channel substrate has individual channels respectively communicating with the nozzles and a common channel communicating with the individual channels. The channel substrate has a first width in a width direction orthogonal to the longitudinal direction. The piezoelectric element substrate is disposed over the channel substrate. The piezoelectric element substrate includes individual liquid chambers connecting the individual channels and the common channel, a diaphragm covering the individual liquid chambers, and a piezoelectric element on the diaphragm. The piezoelectric element is opposed to the individual liquid chambers via the diaphragm in a discharge direction orthogonal to the longitudinal direction and the width direction. The piezoelectric element vibrates the diaphragm to discharge a liquid from the nozzles in the discharge direction. The piezoelectric element substrate has a second width shorter than the first width in the width direction. The holding substrate holds the piezoelectric element substrate. The holding substrate has a third width shorter than the first width in the width direction. The frame is bonded to the channel substrate, with an adhesive in a bonding region, outside the piezoelectric element substrate and the holding substrate in the width direction. The frame has another common channel communicating with the common channel of the channel substrate. The bonding region has a second length longer than the first length of the nozzle region in the longitudinal direction.

In addition, the frame may be bonded to the channel substrate via a component thinner than the piezoelectric element substrate in the discharge direction.

### Aspect 2

According to Aspect 2, in the liquid discharge head of Aspect 1, each of lengths of the first common channel and the second common channel is shorter than the length of the nozzle arrangement region.

In other words, the common channel has a third length shorter than the first length of the nozzle region in the longitudinal direction, and said another common channel has a fourth length shorter than the first length of the nozzle region in the longitudinal direction.

### Aspect 3

According to Aspect 3, in the liquid discharge head of Aspect 1, each of lengths of the first common channel and the second common channel is longer than the length of the nozzle arrangement region.

In other words, the common channel has a third length longer than the first length of the nozzle region in the longitudinal direction, and said another common channel has a fourth length longer than the first length of the nozzle region in the longitudinal direction.

### Aspect 4

According to Aspect 4, in the liquid discharge head of any one of Aspects 1 to 3, the bonding region surrounds a non-bonded portion to which an adhesive is not applied. The non-bonded portion is disposed outside both the first common channel and the second common channel.

In other words, the bonding region has a bonding part applied with the adhesive and a non-bonding part not applied with the adhesive. The non-bonding part is disposed outside said another common channel in the longitudinal direction.

### Aspect 5

According to Aspect 5, in the liquid discharge head of Aspect 4, a width of the non-bonded portion is as large as a width of the first common channel and the second common channel.

In other words, the non-bonding part has the same width as the common channel and said another common channel in the transverse direction.

### Aspect 6

According to Aspect 6, in the liquid discharge head of Aspect 4 or 5, the non-bonded portion extends to an outside of the nozzle arrangement region.

In other words, the non-bonding part extends to an outside of the nozzle region in the longitudinal direction.

### Aspect 7

According to Aspect 7, in the liquid discharge head of any one of Aspects 4 to 6, the adhesive is applied to a portion outside the non-bonded portion.

In other words, the bonding part surrounds the non-bonding part.

### Aspect 8

According to Aspect 8, in the liquid discharge head of any one of Aspects 1 to 7, the frame and the holding substrate are not directly bonded to each other.

In other words, the frame is indirectly bonded to the holding substrate.

### Aspect 9

According to Aspect 9, in the liquid discharge head of any one of Aspects 1 to 8, the frame has an opening formed of a through hole.

In other words, the frame has a through hole having an opening.

### Aspect 10

According to Aspect 10, a liquid discharge unit includes the liquid discharge head of any one of Aspects 1 to 9.

In other words, a liquid discharge unit includes the liquid discharge head according to any one of Aspects 1 to 9 and a carriage mounting the liquid discharge head to move the liquid discharge head.

### Aspect 11

According to Aspect 11, a liquid discharge apparatus includes the liquid discharge head of any one of Aspects 1 to 9.

In other words, a liquid discharge apparatus includes the liquid discharge head according to any one of Aspects 1 to 9, to discharge a liquid to a recording medium and a conveyor to convey the recording medium to the liquid discharge head.

### Aspect 12

According to Aspect 12, a liquid discharge apparatus includes the liquid discharge unit of Aspect 10.

In other words, a liquid discharge apparatus includes the liquid discharge unit according to Aspect 10 and a conveyor to convey a recording medium to the liquid discharge head.

### Aspect 13

A liquid discharge head includes a nozzle substrate, a channel substrate, and a frame. The nozzle substrate has a nozzle region having nozzles arrayed in a longitudinal direction of the nozzle region. The nozzle region has a first length in the longitudinal direction. The channel substrate is disposed over the nozzle substrate. The channel substrate has individual channels respectively communicating with the nozzles and a common channel communicating with the individual channels. The frame is bonded to the channel substrate with an adhesive in a bonding region. The frame has another common channel communicating with the common channel of the channel substrate. The bonding region has a second length longer than the first length of the nozzle region in the longitudinal direction.

As described above, according to one aspect of the present disclosure, tensile stress generated during adhesive curing is uniformly applied to an entire nozzle arrangement region. Accordingly, an inkjet head can be provided that can reduce variations in the discharge speed near both ends thereof and also can reduce variations in the discharge speed in the nozzle arrangement region, to prevent low image quality.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

1. A liquid discharge head comprising:
a nozzle substrate having a nozzle region having nozzles arrayed in a longitudinal direction of the nozzle region,
the nozzle region having a first length in the longitudinal direction;
a channel substrate over the nozzle substrate,
the channel substrate having:
individual channels respectively communicating with the nozzles; and
a common channel communicating with the individual channels,
the channel substrate having a first width in a width direction orthogonal to the longitudinal direction;
a piezoelectric element substrate, over the channel substrate, including:
individual liquid chambers connecting the individual channels and the common channel;
a diaphragm covering the individual liquid chambers; and
a piezoelectric element on the diaphragm,
the piezoelectric element opposed to the individual liquid chambers via the diaphragm in a discharge direction orthogonal to the longitudinal direction and the width direction,
the piezoelectric element to vibrate the diaphragm to discharge a liquid from the nozzles in the discharge direction, and
the piezoelectric element substrate having a second width shorter than the first width in the width direction;
a holding substrate holding the piezoelectric element substrate,
the holding substrate having a third width shorter than the first width in the width direction; and
a frame bonded to the channel substrate, with an adhesive in a bonding region, outside the piezoelectric element substrate and the holding substrate in the width direction,
the frame having another common channel communicating with the common channel of the channel substrate, and
the bonding region having a second length longer than the first length of the nozzle region in the longitudinal direction.

2. The liquid discharge head according to claim 1,
wherein the frame is bonded to the channel substrate via a component thinner than the piezoelectric element substrate in the discharge direction.

3. The liquid discharge head according to claim 1,
wherein the common channel has a third length shorter than the first length of the nozzle region in the longitudinal direction, and
said another common channel has a fourth length shorter than the first length of the nozzle region in the longitudinal direction.

4. The liquid discharge head according to claim 1,
wherein the common channel has a third length longer than the first length of the nozzle region in the longitudinal direction, and
said another common channel has a fourth length longer than the first length of the nozzle region in the longitudinal direction.

5. The liquid discharge head according to claim 1,
wherein the bonding region has:
a bonding part applied with the adhesive; and
a non-bonding part not applied with the adhesive, and
the non-bonding part is disposed outside said another common channel in the longitudinal direction.

6. The liquid discharge head according to claim 5,
wherein the non-bonding part has the same width as the common channel and said another common channel in the width direction.

7. The liquid discharge head according to claim 5,
wherein the non-bonding part extends to an outside of the nozzle region in the longitudinal direction.

8. The liquid discharge head according to claim 5,
wherein the bonding part surrounds the non-bonding part.

9. The liquid discharge head according to claim 1,
wherein the frame is indirectly bonded to the holding substrate.

10. The liquid discharge head according to claim 1,
wherein the frame has a through hole having an opening.

11. A liquid discharge unit comprising:
the liquid discharge head according to claim 1; and
a carriage mounting the liquid discharge head to move the liquid discharge head.

12. A liquid discharge apparatus comprising:
the liquid discharge head according to claim 1, to discharge the liquid to a recording medium; and
a conveyor to convey the recording medium to the liquid discharge head.

13. A liquid discharge apparatus comprising:
the liquid discharge unit according to claim 11; and
a conveyor to convey a recording medium to the liquid discharge head.

14. A liquid discharge head comprising:
a nozzle substrate having a nozzle region having nozzles arrayed in a longitudinal direction of the nozzle region,
the nozzle region having a first length in the longitudinal direction;
a channel substrate over the nozzle substrate,
the channel substrate having:
individual channels respectively communicating with the nozzles; and
a common channel communicating with the individual channels; and
a frame bonded to the channel substrate with an adhesive in a bonding region,
the frame having another common channel communicating with the common channel of the channel substrate, and
the bonding region having a second length longer than the first length of the nozzle region in the longitudinal direction.
